(19) United States
(12) Patent Application Publication
(10) Pub. No.: US 2003/0227366 A1
(43) Pub. Date: Dec. 11, 2003

(54) Inductor structure and manufacturing method for the inductor structure

(76) Inventor: Chang-Liang Lin, Kuishan Hsiang (TW)

Correspondence Address: BRUCE H. TROXELL, SUITE 1404, 5205 LEESBURG PIKE, FALLS CHURCH, VA, 22041, US

(21) Appl. No.: 10/161,699

(22) Filed: Jun. 5, 2002

(51) Int. Cl. H01F 17/04

(52) U.S. Cl. 336/221

(57) ABSTRACT

Inductor structure and manufacturing method for the inductor structure. The inductor structure includes a frame body defining a cavity having two openings and a conductive coil unit fitted on a magnetic core. The coil unit and the magnetic core are movably disposed in a predetermined position in the cavity. A filling material is filled into the cavity to fix the coil unit and the magnetic core. The coil unit has two flattened terminals extending out of the cavity. The terminals are bent downward from the frame body and received in dents formed on a bottom wall of the frame body.

### BACKGROUND OF THE INVENTION

The present invention is related to an inductor structure and a manufacturing method for the inductor structure. The manufacturing method is simplified and the inductance of the inductor is changeable.

A conventional inductor is used to insulate DC and AC signals from each other. The conventional inductors are widely used various circuits such as stereo, sound divider, modem, etc. for regulating signal frequency of current transmission. U.S. Pat. Nos. 7,125,880 and 7,110,535 disclose typical conductors.

A conventional inductor includes a housing and an iron core (magnetic core) fixed on an end face of the housing. A coil is wound around the iron core. Two terminals of the coil extend from two sides of the housing and are bent and soldered. Then, a cap member is mounted on the housing to seal a cavity of the housing in which the coil is disposed. A base seat having an external conductive terminal is connected with the bottom side of the housing to make the terminals of the coil contact with the external conductive terminal. In the conventional structure, a ceramic mud is often filled into the cavity to fix the coil.

It is relatively troublesome to manufacture the above conventional inductor. Taiwanese Patent No. 89110219 discloses a manufacturing method for plate-shaped conductor. Taiwanese Patent No. 87113898 discloses a manufacturing method for an inductor. Taiwanese Patent No. 88121966 discloses a winding type inductor. Taiwanese Patent No. 88108824 discloses a manufacturing method for an inductor. Taiwanese Patent No. 8911869 discloses an inductor. Taiwanese Patent No. 89219886 discloses a magnetic core of an inductor. Taiwanese Patent No. 89200104 discloses an iron core structure of mini-inductor. These patents provide improved manufacturing methods for inductors.

It is known that the current passing through the inductor changes to cause magnetic line variation rate. That is, the greater the inductance is, the greater the magnetic line variation rate is or the greater the dielectric capacity of magnetic core relative to air is. Therefore, when changing the inductance of the conventional inductor, it is often necessary to recast the mold and provide another specification of coil and magnetic core. This increases the cost. The above patents all fail to provide a measure to solve this problem.

### SUMMARY OF THE INVENTION

It is therefore a primary object of the present invention to provide an inductor structure and manufacturing method for the inductor structure. The inductor structure includes a frame body defining a cavity having two openings and a conductive coil unit fitted on an iron core. The coil unit and the magnetic core are movably disposed in a predetermined position in the cavity. A filling material is filled into the cavity to fix the coil unit and the magnetic core. The coil unit has two flattened terminals extending out of the cavity in a direction normal to the axis of the iron core. The terminals are bent from the frame body and fixed on a wall of the frame body. When it is desired to change the inductance of the inductor, a user only needs to replace the iron core and the coil. Accordingly, without recasting the mold, another specification of inductance or magnetic line can be achieved.

It is a further object of the present invention to provide the above inductor structure and manufacturing method for the inductor structure. A filling material is then filled into the cavity of the frame body to locate the coil unit and the iron core in a fixed position in the cavity. The terminals are bent downward from the frame body and fixedly received in dents formed on the bottom wall of the frame body.

The present invention can be best understood through the following description and accompanying drawings wherein:

### BRIEF DESCRIPTION OF THE DRAWINGS

FIG. 1 is a perspective exploded view of the inductor of the present invention;

FIG. 2 is a perspective assembled view of the inductor of the present invention;

FIG. 3 is a bottom perspective view of the inductor of the present invention according to FIG. 2; and

FIG. 4 is a flow chart of the manufacturing method for the inductor of the present invention.

### DETAILED DESCRIPTION OF THE PREFERRED EMBODIMENTS

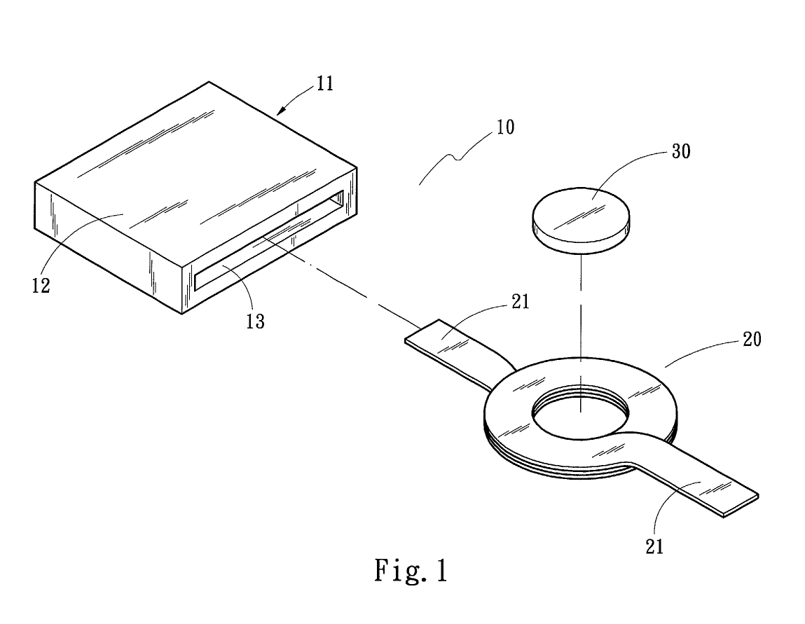

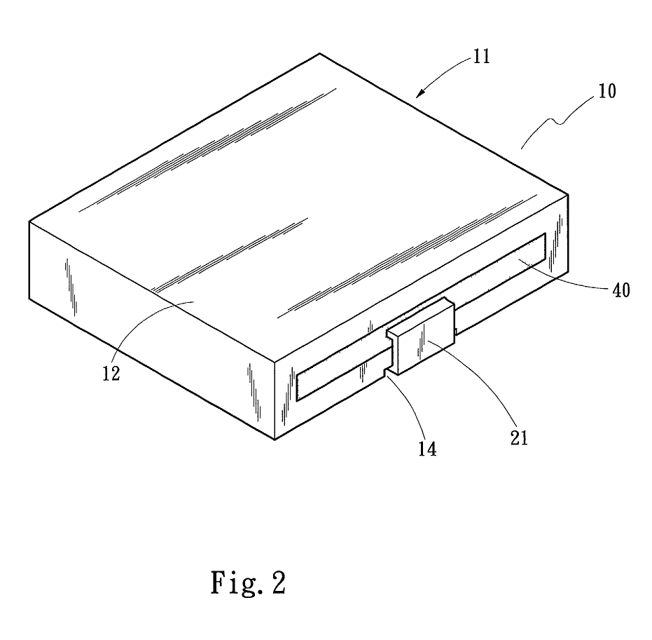

Please refer to FIGS. 1 and 2. The inductor 10 of the present invention includes a frame body 11 made of iron material. The frame body 11 has four side walls 12 defining a cavity 13 having two openings in a horizontal reference axis. The inductor 10 further includes a conductive coil unit 20 which is an annular body. The coil unit 20 is fitted around an iron-made cylindrical magnetic core 30. In the horizontal reference axis, the conductive coil unit 20 has two flat terminals 21. The coil unit 20 fitted around the magnetic core 30 is movably disposed in the cavity 13 of the frame body 11. The terminals 21 of the coil unit 20 extend out of the cavity 13 from the openings of the frame body 11. As shown in FIG. 2, a filling material 40 is filled in the cavity 13 for fixing the coil unit 20 and the magnetic core 30 in a predetermined position in the cavity 13.

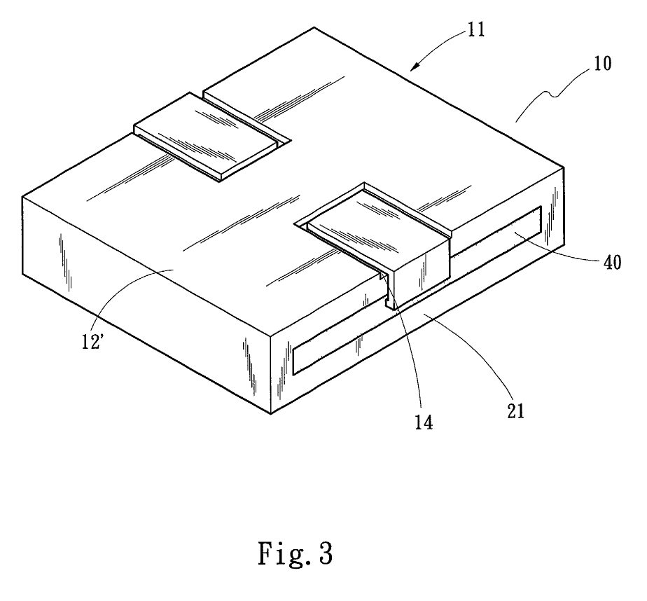

Referring to FIG. 3, the bottom wall 12′ of the frame body 11 is formed with dents 14 corresponding to the terminals 21. The terminals 21 of the coil unit 20 are bent downward from the openings of the frame body 11 and received in the dents 14 to form the inductor 10.

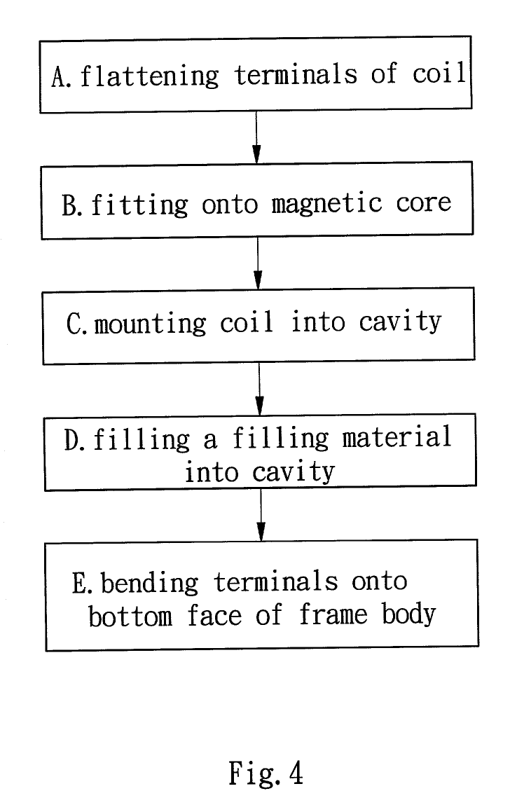

FIG. 4 shows the manufacturing method for the inductor 10 of the present invention. The manufacturing method includes a step of providing an annular conductive coil 20 with two flattened terminals 21. In a preferred embodiment, the flattened terminal 21 has a thickness of about 0.35 mm and a width of about 3.6˜3.8 mm. In practice, the paint on the terminal 21 is scraped off and then the terminal 21 is electroplated with tin. In a next step of the manufacturing method, the coil 20 is placed onto the magnetic core 30. Then, a tool is used to place the coil 20 into the cavity 13 of the frame body 11 and locate the coil 20 in a predetermined position. Basically, the magnetic core 30 is positioned at the center of the cavity 13 with the terminals 21 respectively extending out of the cavity 13 from the openings of the frame body 11. A filling material 40 is then filled into the cavity 13. Then, the terminals 21 are bent downward from the openings of the frame body 11 and fixedly received in the dents 14 of the bottom wall 12′ of the frame body 11.

According to the above arrangement, the present invention has the following advantages:

1. The cavity 13 of the frame body 11 has two openings so that the conductive coil unit 20 and the magnetic core 30 are movably disposed in the cavity 13. When it is desired to change the inductance, a user only needs to remove the filling material and replace the conductive coil 20. This lowers the manufacturing cost of the inductor.

2. The frame body 11 and the magnetic core 30 can be reused, while having different inductances. Accordingly, it is no more necessary to recast the mold as in the conventional measure.

3. The assembly of the frame body 11, magnetic core 30 and conductive coil 20 has a structure much simpler than that of the conventional structure including a cap, a base seat and a housing soldered together. Accordingly, the shortcomings existing in the conventional manufacturing method are eliminated.

The above embodiments are only used to illustrate the present invention, not intended to limit the scope thereof. Many modifications of the above embodiments can be made without departing from the spirit of the present invention.

What is claimed is:

1. Inductor structure comprising:
a frame body defining a cavity having two openings;
a conductive coil unit fitted on a magnetic core, the coil unit with the magnetic core being movably disposed in a predetermined position in the cavity; and
a filling material filled in the cavity, the coil unit having two terminals extending out of the cavity from the openings thereof, the terminals being bent and overlaid on a bottom wall of the frame body.

2. Inductor structure as claimed in claim 1, wherein the bottom wall of the frame body is formed with at least one dent for receiving the terminal therein.

3. Inductor structure as claimed in claim 1, wherein the terminal is flat.

4. Manufacturing method for an inductor, comprising steps of:
(a) providing a conductive coil unit with two flattened terminals;
(b) placing the coil unit onto a magnetic core;
(c) movably positioning the coil unit and the magnetic core into a cavity of a frame body of the inductor;
(d) filling a filling material into the cavity of the frame body; and
(e) downward bending the terminals from the frame body.

5. Manufacturing method for an inductor as claimed in claim 4, wherein in step (e), the terminals are received and located in dents formed on a bottom wall of the frame body.
